(19) United States
(12) Patent Application Publication
(10) Pub. No.: US 2016/0034440 A1
(43) Pub. Date: Feb. 4, 2016

(54) APPARATUS FOR CONTROLLING MOBILE TERMINAL AND METHOD THEREFOR

(71) Applicant: LG ELECTRONICS INC., Seoul (KR)

(72) Inventor: Gunho LEE, Seoul (KR)

(21) Appl. No.: 14/776,230

(22) PCT Filed: Mar. 15, 2013
(86) PCT No.: PCT/KR2013/002107

§ 371 Date: Sep. 14, 2015

(51) Int. Cl. G06F 17/24; G06F 3/0482; G06F 3/16; G06F 3/0484

(52) U.S. Cl. CPC G06F 17/243; G06F 3/0484; G06F 3/0482; G06F 3/04842; G06F 3/167

(57) ABSTRACT

An apparatus for controlling a mobile terminal allowing a user to easily and quickly select and transmit desired information and a method thereof are provided. The method for controlling a mobile terminal includes detecting information used in at least one application program, displaying a character input window on a display unit, and displaying information selected from the detected information in the character input window.

### BACKGROUND OF THE INVENTION

1. Field of the Invention

The present disclosure relates to an apparatus for controlling a mobile terminal and a method thereof.

2. Background of the Invention

Generally, a mobile terminal (portable electronic apparatus) is a portable apparatus that is equipped with at least one or more among a voice and image communication call function, an information output and input function, and a data storage function. In addition, in response to an increasing demand for diversified functions, the mobile terminal has been realized in the form of a multimedia player with multiple functions (for example, as photographing a photographic subject as a still image or a moving image, reproducing digital audio and video compression files, playing a game, receiving a broadcast or the like).

### SUMMARY OF THE INVENTION

Therefore, an object of the present invention is to provide an apparatus for controlling a mobile terminal capable of storing information (for example, a character string, a photograph (or a picture), a document, an audio file, a video file, and the like) collected through a plurality of application programs (App), and subsequently providing the stored information when a character (or message) input window is activated by a user, thereby allowing the user to easily and quickly select and transmit desired information, and a method thereof.

To achieve these and other advantages and in accordance with the purpose of this specification, as embodied and broadly described herein, a method for controlling a mobile terminal includes; detecting information used in at least one application program; displaying a character input window on a display unit; and displaying information selected from the detected information in the character input window.

In an example related to the present disclosure, the information used in the at least one application program may be information which has been most recently used in the at least one application program or may be information having high frequency in use among information used in the at least one application program.

In an example related to the present disclosure, the information selected from the detected information may be information associated with information input to the character input window among the detected information.

In an example related to the present disclosure, the method may further include: displaying the detected information on the display unit.

In an example related to the present disclosure, the detected information may include: first information indicating at least one application program in which the information has been used; second information indicating information used in the at least one application program; and third information indicating a date and time on and at which the second information has been generated.

In an example related to the present disclosure, the detected information may be one or more of a character, a character string, a phone number, an image file, a video file, an audio file, and a document file.

In an example related to the present disclosure, the detecting of information may include: selecting at least one application program from an application program list; detecting information used in the selected application program; and storing the detected information as recommendation information in a storage unit.

In an example related to the present disclosure, the method may further include: when a file is requested in a state in which the character input window is displayed on the display unit, detecting files from the detected information; and displaying a list of the detected files on the display unit.

In an example related to the present disclosure, a file selected from the displayed list may be attached to the character input window.

In an example related to the present disclosure, the file may be any one of a document file, an audio file, a video file, and a picture file, and the method may further include: when a voice for requesting any one of the document file, the audio file, the video file, and the picture file is received, detecting a file corresponding to the received voice from the recommendation information; and displaying the detected file on the display unit.

To achieve these and other advantages and in accordance with the purpose of this specification, as embodied and broadly described herein, a mobile terminal includes; a control unit configured to detect information used in at least one application program; and a display unit configured to display a character input window, wherein the control unit displays information selected from the detected information in the character input window.

### BRIEF DESCRIPTION OF THE DRAWINGS

FIG. 1 is a block diagram illustrating a mobile terminal according to exemplary embodiments of the present disclosure.

FIGS. 2A and 2B are conceptual views of a communication system in which a mobile terminal according to an exemplary embodiment of the present disclosure is operable.

FIG. 3 is a flow chart illustrating a method for controlling a mobile terminal according to a first exemplary embodiment of the present disclosure.

FIG. 4 is a view illustrating an example of application programs installed in a mobile terminal.

FIG. 5 is a view illustrating an example of a list of application programs (App) displayed according to the first exemplary embodiment of the present disclosure.

FIG. 6 is a view illustrating an example of a message input window according to the first exemplary embodiment of the present disclosure.

FIG. 7 is a view illustrating an example of recommendation information according to the first exemplary embodiment of the present disclosure.

FIG. 8 is a view illustrating another example of recommendation information according to the first exemplary embodiment of the present disclosure.

FIG. 9 is a view illustrating an example of recommendation information displayed in a text (or message) input window according to the first exemplary embodiment of the present disclosure.

FIG. 10 is a flow chart illustrating a method for controlling a mobile terminal according to a second exemplary embodiment of the present disclosure.

FIG. 11 is a view illustrating an example of an attachment file icon included in a message input window according to the second exemplary embodiment of the present disclosure.

FIG. 12 is a view illustrating an example of a recommendation file according to the second exemplary embodiment of the present disclosure.

FIG. 13 is a view illustrating another example of files according to the second exemplary embodiment of the present disclosure.

FIG. 14 is a view illustrating an example of a recommendation file displayed in a text (or message) input window according to the second exemplary embodiment of the present disclosure.

### DETAILED DESCRIPTION OF THE INVENTION

The terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, steps, operations, elements, components, and/or groups thereof.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

The exemplary embodiments of the present invention will now be described with reference to the accompanying drawings, in which like numbers refer to like elements throughout.

In describing the present invention, if a detailed explanation for a related known function or construction is considered to unnecessarily divert the gist of the present invention, such explanation has been omitted but would be understood by those skilled in the art. The accompanying drawings of the present invention aim to facilitate understanding of the present invention and should not be construed as limited to the accompanying drawings. The technical idea of the present invention should be interpreted to embrace all such alterations, modifications, and variations in addition to the accompanying drawings.

Mobile terminals described in the present disclosure may include mobile phones, smart phones, notebook computers, tablet computers, digital broadcast receivers, PDAs (Personal Digital Assistants), PMPs (Portable Multimedia Player), navigation devices, slate PCs, tablet PCs, ultra-books, and the like.

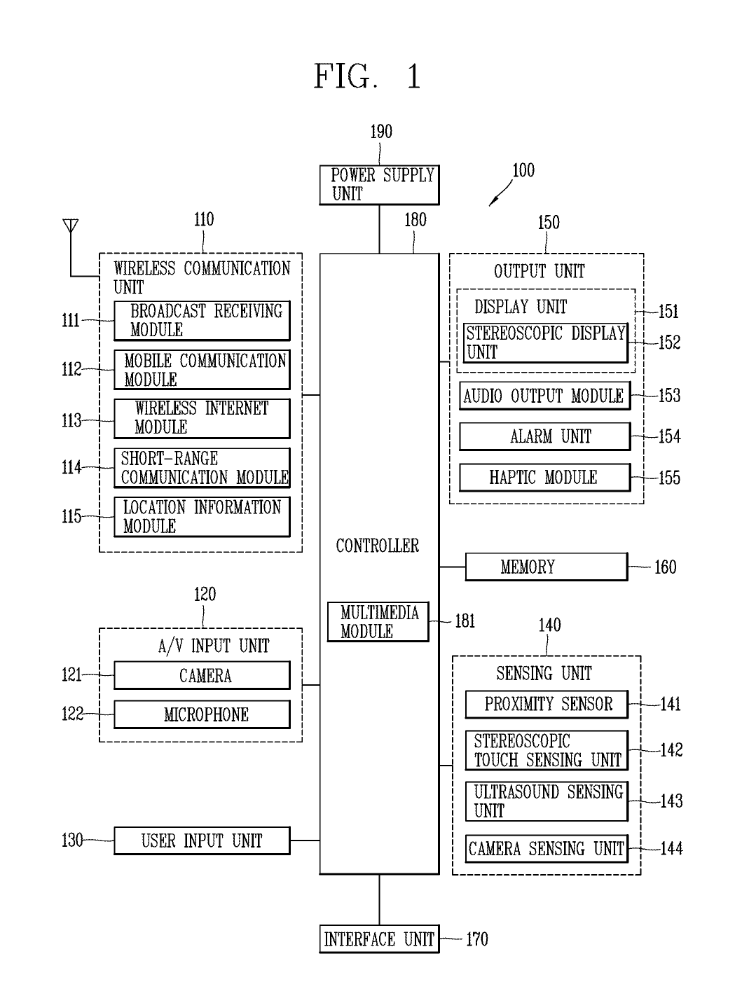

FIG. 1 is a block diagram of a mobile terminal according to an embodiment of the present invention.

The mobile terminal 100 may include a wireless communication unit 110, an A/V (Audio/Video) input unit 120, a user input unit 130, a sensing unit 140, an output unit 150, a memory 160, an interface unit 170, a controller 180, and a power supply unit 190, etc. FIG. 1 shows the mobile terminal as having various components, but it should be understood that implementing all of the illustrated components is not a requirement. Greater or fewer components may alternatively be implemented.

The elements of the mobile terminal will be described in detail as follows.

The wireless communication unit 110 typically includes one or more modules allowing radio communication between the mobile terminal 100 and a wireless communication system or a network in which the mobile terminal is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel.

The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

The broadcast associated information may refer to information associated with a broadcast channel, a broadcast program or a broadcast service provider. The broadcast associated information may also be provided via a mobile communication network and, in this case, the broadcast associated information may be received by the mobile communication module 112.

The broadcast associated information may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. The broadcast receiving module 111 may be configured to be suitable for every broadcast system that provides a broadcast signal as well as the above-mentioned digital broadcast systems.

Broadcast signals and/or broadcast-associated information received via the broadcast receiving module 111 may be stored in the memory 160.

The mobile communication module 112 transmits and/or receives radio signals to and/or from at least one of a base station, an external terminal and a server. Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for checking or acquiring a location (or position) of the mobile terminal. A typical example of the location information module is a GPS (Global Positioning System) or a WiFi (Wireless Fidelity) module.

With reference to FIG. 1, the A/V input unit 120 is configured to receive an audio or video signal. The A/V input unit 120 may include a camera 121 and a microphone 122. The camera 121 processes image data of still pictures or video obtained by an image capture device in a video capturing mode or an image capturing mode. The processed image frames may be displayed on a display unit 151.

The image frames processed by the camera 121 may be stored in the memory 160 (or other storage medium) or transmitted via the wireless communication unit 110. Two or more cameras 121 may be provided according to the configuration of the mobile terminal.

The microphone 122 may receive sounds (audible data) via a microphone in a phone call mode, a recording mode, a voice recognition mode, and the like, and can process such sounds into audio data. The processed audio (voice) data may be converted for output into a format transmittable to a mobile communication base station via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 may generate input data from commands entered by a user to control various operations of the mobile terminal. The user input unit 130 may include a keypad, a dome switch, a touch pad, a jog wheel, a jog switch, and the like.

The sensing unit 140 detects a current status (or state) of the mobile terminal 100 such as an opened or closed state of the mobile terminal 100, a location of the mobile terminal 100, the presence or absence of user contact with the mobile terminal 100 (i.e., touch inputs), the orientation of the mobile terminal 100, an acceleration or deceleration movement and direction of the mobile terminal 100, etc., and generates commands or signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device.

The output unit 150 is configured to provide outputs in a visual, audible, and/or tactile manner (e.g., audio signal, video signal, alarm signal, vibration signal, etc.). The output unit 150 may include the display unit 151, an audio output module 153, an alarm unit 154, a haptic module 155, and the like.

The display unit 151 may display (output) information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, and an e-ink display.

Some of them may be configured to be transparent or light-transmissive to allow viewing of the exterior, which may be called transparent displays. A typical transparent display may be, for example, a TOLED (Transparent Organic Light Emitting Diode) display, or the like. Through such configuration, the user can view an object positioned at the rear side of the terminal body through the region occupied by the display unit 151 of the terminal body.

The mobile terminal 100 may include two or more display units according to its particular desired embodiment. For example, a plurality of display units may be separately or integrally disposed on one surface of the mobile terminal, or may be separately disposed on mutually different surfaces.

Also, the display unit 151 may be configured as a stereoscopic display unit 152 displaying a stereoscopic image.

Here, the stereoscopic image may be a three-dimensional (3D) stereoscopic image, and the 3D stereoscopic image is an image refers to an image making a viewer feel that a gradual depth and reality of an object on a monitor or a screen is the same as a reality space. A 3D stereoscopic image is implemented by using binocular disparity. Binocular disparity refers to disparity made by the positions of two eyes. When two eyes view different 2D images, the images are transferred to the brain through the retina and combined in the brain to provide the perception of depth and reality sense.

The stereoscopic display unit 152 may employ a stereoscopic display scheme such as stereoscopic scheme (a glass scheme), an auto-stereoscopic scheme (glassless scheme), a projection scheme (holographic scheme), or the like. Stereoscopic schemes commonly used for home television receivers, or the like, include Wheatstone stereoscopic scheme, or the like.

The auto-stereoscopic scheme includes, for example, a parallax barrier scheme, a lenticular scheme, an integral imaging scheme, or the like. The projection scheme includes a reflective holographic scheme, a transmissive holographic scheme, or the like.

In general, a 3D stereoscopic image is comprised of a left image (a left eye image) and a right image (a right eye image). According to how left and right images are combined into a 3D stereoscopic image, the 3D stereoscopic imaging method is divided into a top-down method in which left and right images are disposed up and down in a frame, an L-to-R (left-to-right, side by side) method in which left and right images are disposed left and right in a frame, a checker board method in which fragments of left and right images are disposed in a tile form, an interlaced method in which left and right images are alternately disposed by columns and rows, and a time sequential (or frame by frame) method in which left and right images are alternately displayed by time.

Also, as for a 3D thumbnail image, a left image thumbnail and a right image thumbnail are generated from a left image and a right image of the original image frame, respectively, and then combined to generate a single 3D thumbnail image. In general, thumbnail refers to a reduced image or a reduced still image. The thusly generated left image thumbnail and the right image thumbnail are displayed with a horizontal distance difference therebetween by a depth corresponding to the disparity between the left image and the right image on the screen, providing a stereoscopic space sense.

A left image and a right image required for implementing a 3D stereoscopic image is displayed on the stereoscopic display unit 152 by a stereoscopic processing unit 152a. The stereoscopic processing unit may receive the 3D image and extract the left image and the right image, or may receive the 2D image and change it into a left image and a right image.

Meanwhile, when the display unit 151 and a sensor (referred to as a ‘touch sensor’, hereinafter) for detecting a touch operation are overlaid in a layered manner to form a touch screen, the display unit 151 may function as both an input device and an output device. The touch sensor may have a form of a touch film, a touch sheet, a touch pad, and the like.

The touch sensor may be configured to convert pressure applied to a particular portion of the display unit 151 or a change in the capacitance or the like generated at a particular portion of the display unit 151 into an electrical input signal. The touch sensor may be configured to detect the pressure when a touch is applied, as well as the touched position and area.

When there is a touch input with respect to the touch sensor, a corresponding signal (signals) are transmitted to a touch controller. The touch controller processes the signals and transmits corresponding data to the controller 180. Accordingly, the controller 180 may recognize which portion of the display unit 151 has been touched.

With reference to FIG. 1, a proximity sensor 141 may be disposed within or near the touch screen. The proximity sensor 141 is a sensor for detecting the presence or absence of an object relative to a certain detection surface or an object that exists nearby by using the force of electromagnetism or infrared rays without a physical contact. Thus, the proximity sensor 141 has a considerably longer life span compared with a contact type sensor, and it can be utilized for various purposes.

Examples of the proximity sensor 141 may include a transmission type photoelectric sensor, a direct reflection type photoelectric sensor, a mirror-reflection type photoelectric sensor, an RF oscillation type proximity sensor, a capacitance type proximity sensor, a magnetic proximity sensor, an infrared proximity sensor, and the like. In case where the touch screen is the capacitance type, proximity of the pointer is detected by a change in electric field according to the proximity of the pointer. In this case, the touch screen (touch sensor) may be classified as a proximity sensor.

In the following description, for the sake of brevity, recognition of the pointer positioned to be close to the touch screen will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

By employing the proximity sensor 141, a proximity touch and a proximity touch pattern (e.g., a proximity touch distance, a proximity touch speed, a proximity touch time, a proximity touch position, a proximity touch movement state, or the like) can be detected, and information corresponding to the detected proximity touch operation and the proximity touch pattern can be outputted to the touch screen.

When a touch sensor is overlaid on the stereoscopic display unit 152 in a layered manner, or when the stereoscopic display unit and a 3D sensor sensing a touch operation are combined, the stereoscopic display unit 152 may also be used as a 3D input device.

As an example of the 3D sensor, the sensing unit 140 may include a proximity sensor 141, a stereoscopic touch sensing unit 142, an ultrasonic sensing unit 143, and a camera sensing unit 144.

The proximity sensor 141 detects the distance between a sensing object (e.g., the user's finger or a stylus) applying a touch by using the force of electromagnetism or infrared rays without a mechanical contact and a detect surface. By using the distance, the terminal recognizes which portion of a stereoscopic image has been touched. In particular, when the touch screen is an electrostatic touch screen, the degree of proximity of the sensing object is detected based on a change of an electric field according to proximity of the sensing object, and a touch to the 3D image is recognized by using the degree of proximity.

The stereoscopic touch sensing unit 142 is configured to detect the strength or duration of a touch applied to the touch screen. For example, the stereoscopic touch sensing unit 142 senses pressure applying a touch, and the applied pressure is strong, the stereoscopic touch sensing unit 142 recognizes the touch as a touch with respect to an object positioned to be farther from the touch screen toward the interior of the terminal.

The ultrasonic sensing unit 143 is configured to recognize position information of the sensing object by using ultrasonic waves.

The ultrasonic sensing unit 143 may include, for example, an optical sensor and a plurality of ultrasonic sensors. The optical sensor is configured to sense light, and the ultrasonic sensors may be configured to sense ultrasonic waves. Since light is very faster than ultrasonic waves, light reaches the optical sensor very earlier than ultrasonic waves reach the ultrasonic sensors. Thus, based on light as a reference signal, a position of a wave generation source may be calculated by using a time difference between a time at which light reaches the optical sensor and a time at which ultrasonic waves reach the ultrasonic sensors.

The camera sensing unit 144 includes at least one of a camera, a photo sensor, and a laser sensor.

For example, the camera and the laser sensor may be combined to detect a touch of the sensing object with respect to a 3D stereoscopic image. When distance information detected by a laser sensor is added to a 2D image captured by the camera, 3D information can be obtained.

In another example, a photo sensor may be laminated on the display device. The photo sensor is configured to scan a movement of the sensing object in proximity to the touch screen. In detail, the photo sensor includes photo diodes and transistors at rows and columns to scan content mounted on the photo sensor by using an electrical signal changing according to the quantity of applied light. Namely, the photo sensor calculates the coordinates of the sensing object according to variation of light to thus obtain position information of the sensing object.

The audio output module 153 may convert and output as sound audio data received from the wireless communication unit 110 or stored in the memory 160 in a call signal reception mode, a call mode, a record mode, a voice recognition mode, a broadcast reception mode, and the like. Also, the audio output module 153 may provide audible outputs related to a particular function performed by the mobile terminal 100 (e.g., a call signal reception sound, a message reception sound, etc.). The audio output module 153 may include a speaker, a buzzer, or other sound generating device.

The alarm unit 154 outputs a signal for informing about an occurrence of an event of the mobile terminal 100. Events generated in the mobile terminal may include call signal reception, message reception, key signal inputs, a touch input etc. In addition to video or audio signals, the alarm unit 154 may output signals in a different manner, for example, to inform about an occurrence of an event. The video or audio signals may be also outputted via the audio output module 153, so the display unit 151 and the audio output module 153 may be classified as parts of the alarm unit 154.

A haptic module 155 generates various tactile effects the user may feel. A typical example of the tactile effects generated by the haptic module 155 is vibration. The strength and pattern of the haptic module 155 can be controlled. For example, different vibrations may be combined to be outputted or sequentially outputted.

Besides vibration, the haptic module 155 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 155 may be implemented to allow the user to feel a tactile effect through a muscle sensation such as fingers or arm of the user, as well as transferring the tactile effect through a direct contact. Two or more haptic modules 155 may be provided according to the configuration of the mobile terminal 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via a port.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

Also, when a state of the mobile terminal satisfies pre-set conditions, the controller 180 may execute a locked state for limiting an input of a control command of the user. Also, in the locked state, the controller 180 may control a locked screen displayed in the locked state on the basis of a touch input sensed through the display unit 151.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein.

Software codes can be implemented by a software application written in any suitable programming language. The software codes may be stored in the memory 160 and executed by the controller 180.

Hereinafter, a communication system implementable through the mobile terminal 100 according to an embodiment of the present invention will be described.

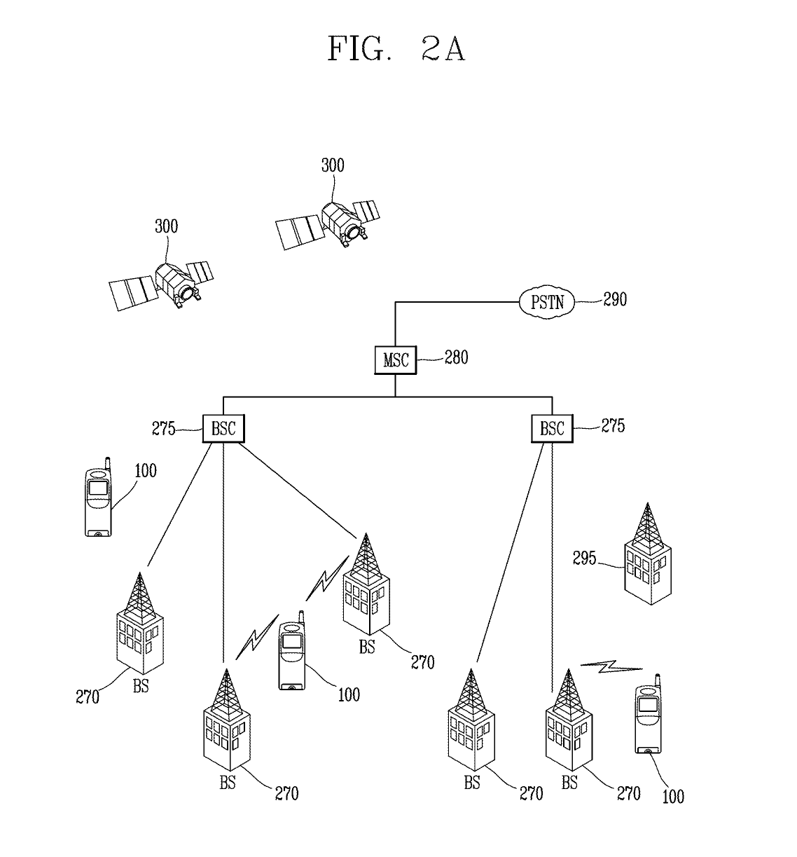

FIGS. 2A and 2B are conceptual views of communication systems in which the mobile terminal 100 according to an embodiment of the present invention is operable.

First, referring to FIG. 2A, a communication system may use different air interfaces and/or physical layers. For example, air interfaces utilized by the communication systems include example, frequency division multiple access (FDMA), time division multiple access (TDMA), code division multiple access (CDMA), and universal mobile telecommunications system (UMTS) (in particular, long term evolution (LTE)), global system for mobile communications (GSM), and the like. As a non-limiting example, the description hereafter relates to a CDMA communication system, but such teachings apply equally to other types of systems.

Hereinafter, for the description purpose, CDMA will be described, but, obviously, the present invention is applicable to any communication system including a CDMA wireless communication system.

Referring to FIG. 2, a CDMA wireless communication system may include a plurality of mobile terminals 100, a plurality of base stations (BSs) 270, base station controllers (BSCs) 275, and a mobile switching center (MSC) 280. The MSC 280 is configured to interface with a public switch telephone network (PSTN) 290. The MSC 280 is also configured to interface with the BSCs 275, which may be coupled to the base stations 270 via backhaul lines. The backhaul lines may be configured in accordance with any of several known interfaces including, for example, E1/T1, ATM, IP, PPP, Frame Relay, HDSL, ADSL, or xDSL. It is to be understood that the system as shown in FIG. 2 may include a plurality of BSCs 275.

Each BS 270 may serve one or more sectors (or regions), each sector covered by an omni-directional antenna or an antenna pointed in a particular direction radially away from the BS 270. Alternatively, each sector may be covered by two or more antennas for diversity reception. Each BS 270 may be configured to support a plurality of frequency assignments, and each frequency assignment has a particular spectrum (e.g., 1.25 MHz, 5 MHz, etc).

The intersection of a sector and frequency assignment may be referred to as a CDMA channel. The BS 270 may also be referred to as base station transceiver subsystems (BTSs) or other equivalent terms. In such case, the term “base station” may be used to collectively refer to a single BSC 275 and at least one BS 270. The base station may also be referred to as a “cell site”. Alternatively, individual sectors of a particular BS 270 may be referred to as a plurality of cell sites.

As shown in FIG. 2A, a broadcasting transmitter (BT) 295 transmits a broadcast signal to the mobile terminals 100 operating within the system. The broadcast receiving module 111 as shown in FIG. 1 is provided at the terminal 100 to receive broadcast signals transmitted by the BT 295.

Also, in FIG. 2A, several global positioning systems (GPS) satellites 300 are shown. The satellites 300 help locate at least one of a plurality of terminals 100. In FIG. 2, several satellites 300 are depicted, but it is understood that useful positioning information may be obtained with any number of satellites. The GPS module 115 as shown in FIG. 1 is typically configured to cooperate with the satellites 300 to obtain desired positioning information. Instead of or in addition to GPS tracking techniques, other technologies that may track the location of the mobile terminals may be used. In addition, at least one of the GPS satellites 300 may selectively or additionally handle satellite DMB transmissions.

As one typical operation of the wireless communication system, the BSs 270 receive reverse-link signals from various mobile terminals 100. The mobile terminals 100 typically engaging in calls, messaging, and other types of communications. Each reverse-link signal received by a particular base station 270 is processed within the particular BS 270. The resulting data is forwarded to an associated BSC 275. The BSC provides call resource allocation and mobility management functionality including the coordination of soft handoff procedures between BSs 270. The BSCs 275 also route the received data to the MSC 280, which provides additional routing services for interfacing with the PSTN 290. Similarly, the PSTN 290 interfaces with the MSC 280, the MSC interfaces with the BSCs 275, and the BSCs 275 in turn control the BSs 270 to transmit forward-link signals to the mobile terminals 100.

Next, a method of acquiring the location information of a mobile terminal using a WiFi (Wireless Fidelity) positioning system (WPS) will be described with reference to FIG. 2B.

The WiFi positioning system (WPS) 300 refers to a location determination technology based on a wireless local area network (WLAN) using WiFi as a technology for tracking the location of the mobile terminal 100 using a WiFi module provided in the mobile terminal 100 and a wireless access point 320 for transmitting and receiving to and from the WiFi module.

The WiFi positioning system 300 may include a WiFi location determination server 310, a mobile terminal 100, a wireless access point (AP) 320 connected to the mobile terminal 100, and a database 330 stored with any wireless AP information.

The WiFi location determination server 310 extracts the information of the wireless AP 320 connected to the mobile terminal 100 based on a location information request message (or signal) of the mobile terminal 100. The information of the wireless AP 320 may be transmitted to the WiFi location determination server 310 through the mobile terminal 100 or transmitted to the WiFi location determination server 310 from the wireless AP 320.

The information of the wireless AP extracted based on the location information request message of the mobile terminal 100 may be at least one of MAC address, SSID, RSSI, channel information, privacy, network type, signal strength and noise strength.

The WiFi location determination server 310 receives the information of the wireless AP 320 connected to the mobile terminal 100 as described above, and compares the received wireless AP 320 information with information contained in the pre-established database 330 to extract (or analyze) the location information of the mobile terminal 100.

On the other hand, referring to FIG. 2B, as an example, the wireless AP connected to the mobile terminal 100 is illustrated as a first, a second, and a third wireless AP 320. However, the number of wireless APs connected to the mobile terminal 100 may be changed in various ways according to a wireless communication environment in which the mobile terminal 100 is located. When the mobile terminal 100 is connected to at least one of wireless APs, the WiFi positioning system 300 can track the location of the mobile terminal 100.

Next, considering the database 330 stored with any wireless AP information in more detail, various information of any wireless APs disposed at different locations may be stored in the database 330.

The information of any wireless APs stored in the database 330 may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like.

In this manner, any wireless AP information and location information corresponding to the any wireless AP are stored together in the database 330, and thus the WiFi location determination server 310 may retrieve wireless AP information corresponding to the information of the wireless AP 320 connected to the mobile terminal 100 from the database 330 to extract the location information matched to the searched wireless AP, thereby extracting the location information of the mobile terminal 100.

Furthermore, the extracted location information of the mobile terminal 100 may be transmitted to the mobile terminal 100 through the WiFi location determination server 310, thereby acquiring the location information of the mobile terminal 100.

Hereinafter, an apparatus for controlling a mobile terminal capable of storing information (for example, a character string, a picture, a document, an audio file, a video file, and the like) collected through a plurality of application programs (App), and subsequently providing the stored information when a character (or message) input window is activated by a user, thereby allowing the user to easily and quickly select and transmit desired information, and a method thereof will be described with reference to FIGS. 1 through 9.

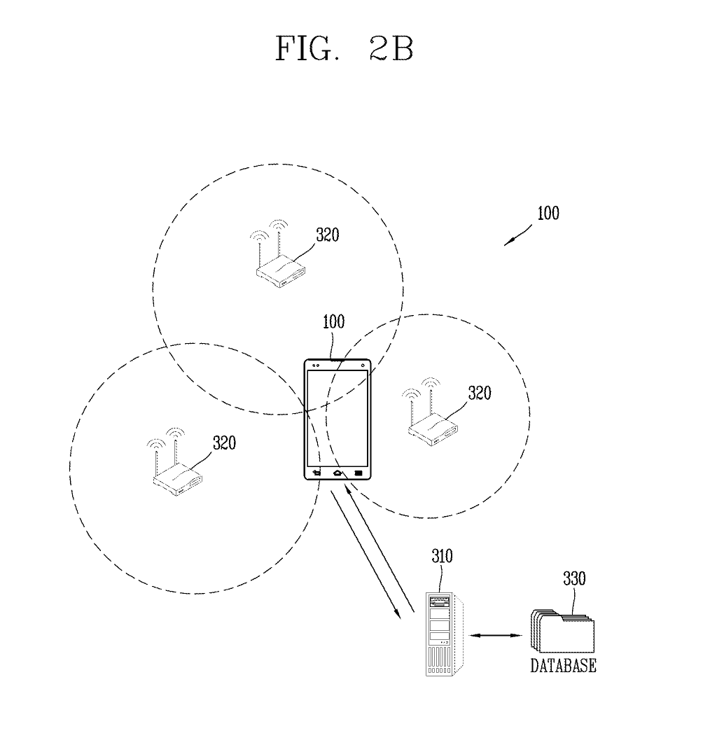

FIG. 3 is a flow chart illustrating a method for controlling a mobile terminal according to a first exemplary embodiment of the present disclosure.

First, the controller displays an application program list (App list) including application programs installed in the mobile terminal 100 on the display unit 151 according to a user request.

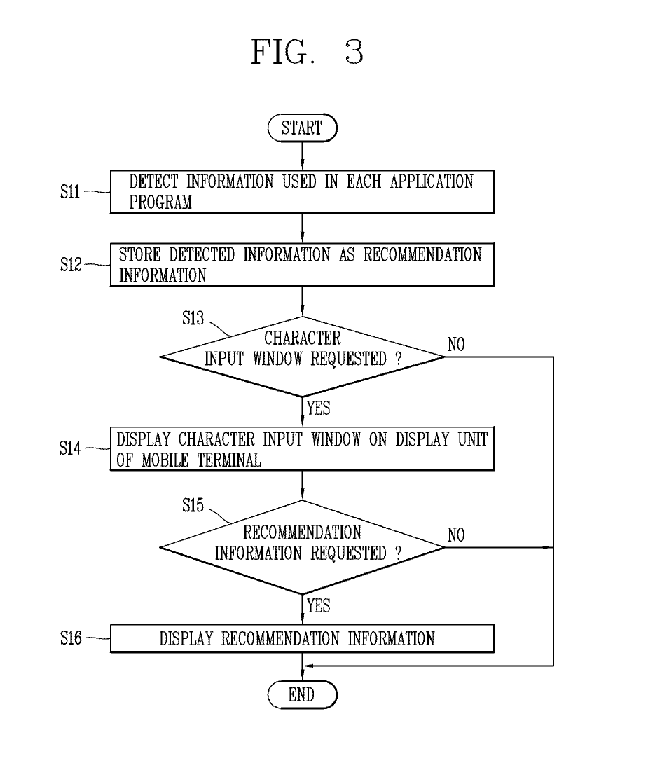

FIG. 4 is a view illustrating an example of application programs installed in the mobile terminal 100.

As illustrated in FIG. 4, a plurality of application programs (first App, second App, . . . , Nth App) 160-1 are installed in the memory 160. For example, an application program related to a message, an application program related to audio (music), an application program related to a picture (an image), an application program related to video, an application program related to a document, an application program related to a phone call, an application program related to navigation, and the like, may be installed in the memory 160.

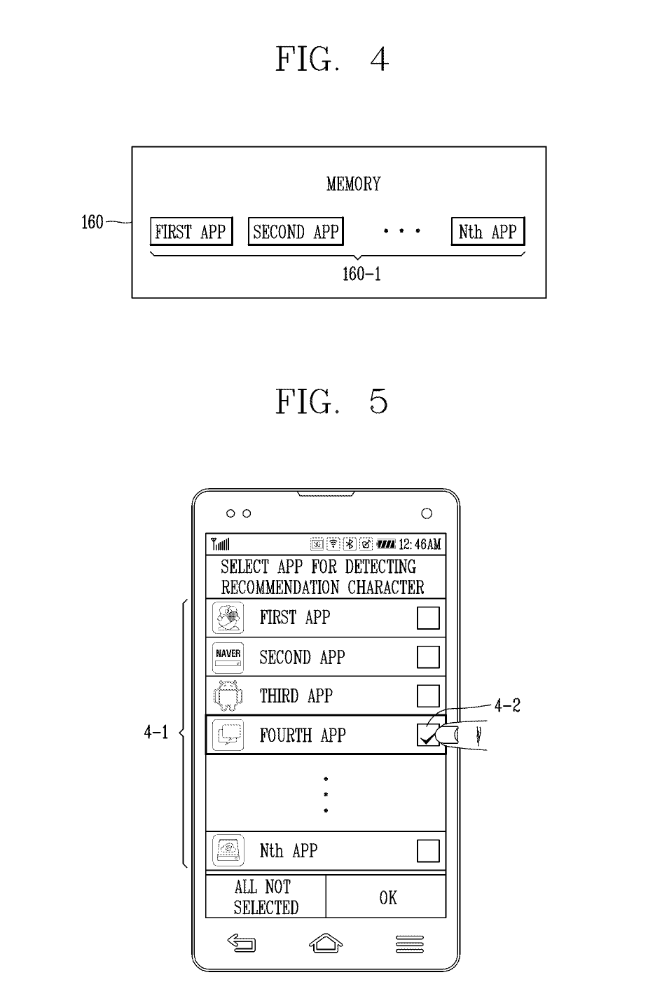

FIG. 5 is a view illustrating an example of a list of application programs (App) displayed according to the first exemplary embodiment of the present disclosure.

As illustrated in FIG. 5, when an application program list for selecting an application program for detecting recommendation information (for example, a character, a character string, a photo file, a document file, an audio file, a video file, and the like) is requested by the user, the control unit 180 displays the application program list on the display unit 151. The application program list includes a plurality of application programs (first App, second App, . . . , Nth App) 4-1 and check boxes 4-2 for selecting an application program for detecting recommendation information (for example, a character, a character string, a photo file, a document file, an audio file, a video file, and the like).

The plurality of application programs 4-1 may include an application program related to a message, an application program related to audio (music), an application program related to a picture (an image), an application program related to video, an application program related to a document, an application program related to a phone call, an application program related to navigation, and the like.

The control unit 180 detects (collects) information used in each application program (for example, an application program related to a message, an application program related to audio (music), an application program related to a picture (an image), an application program related to video, an application program related to a document, an application program related to a phone call, an application program related to navigation, and the like) installed in the mobile terminal 100 in step S11. For example, the control unit 180 detects input information and received information through an application program selected from the application program list among the application programs installed in the mobile terminal 100.

When the application program selected from the application program list is a message-related application program, the control unit 180 detects a message used in the message-related application program. When the application program selected from the application program list is an audio (music)-related application program, the control unit 180 detects audio (music file) used in the audio (music)-related application program. When the application program selected from the application program list is a document-related application program, the control unit 180 detects a character and/or a character string used in the document-related application program. When the application program selected from the application program list is a message service-related application program, the control unit 180 detects a character and/or a character string used in the message service-related application program.

After the used information is detected (or collected), the control unit 180 stores the used information as recommendation information in the memory 160 in step S12. The control unit 180 may store the most recently used information and information with high frequency in use (periodically used information or information which has been used by a number of times equal to or greater than a preset number of times) as the recommendation information in the memory 160. The recommendation information may further include a title of the corresponding application program, category information of the corresponding application program, a thumbnail image of the corresponding application program, a date and a time on and at which the recommendation information was generated, and the like.

The control unit 180 determines whether a text input window (or a message input window) is requested by the user in step S13. For example, the control unit 180 determines whether the text or message-related application program is selected by the user.

When a text input window (or a message input window) is requested by the user, the control unit 180 displays the text input window (or the message input window) on the display unit 151 in step S14. For example, when the text or the message-related application is selected by the user, the control unit 180 displays a text or message input window for inputting a text or message on the display unit 151.

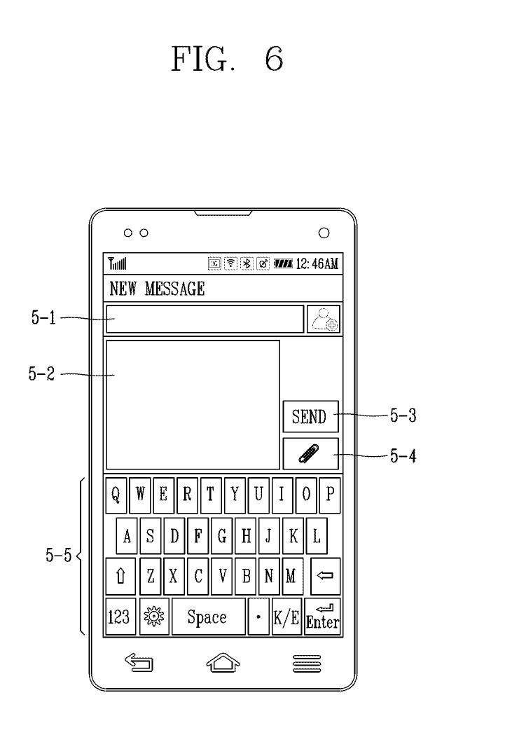

FIG. 6 is a view illustrating an example of a message input window according to the first exemplary embodiment of the present disclosure.

As illustrated in FIG. 6, when the message-related application program is selected by the user, the control unit 180 displays a message input window 5-2 for inputting a message on the display unit 151. The message input window 5-2 may include a receiver information window 5-1 for inputting information regarding a receiver who is to receive a message (for example, a phone number, a name, an e-mail, and the like), a transmission icon 5-3 for transmitting the message, and an attachment file icon 5-4 for attaching a file to be transmitted together with the message. The control unit 180 displays the message input window 5-3 on the display unit 151 and simultaneously displays a virtual keyboard 5-5 on the display unit 151.

The control unit 180 determines whether the recommendation information stored in the memory 160 is requested by the user in step S15. For example, the control unit 180 determines whether a button or an icon for requesting recommendation information stored in the memory 160 is selected or preset voice (for example, recommendation information, character, a recommendation character, and the like) is received.

When the recommendation information stored in the memory 160 is requested by the user, the control unit 180 displays the recommendation information on the display unit 151 in step S16. The control unit 180 may display the recommendation information in order, starting from the most recently used recommendation information in each application program, on the display unit 151.

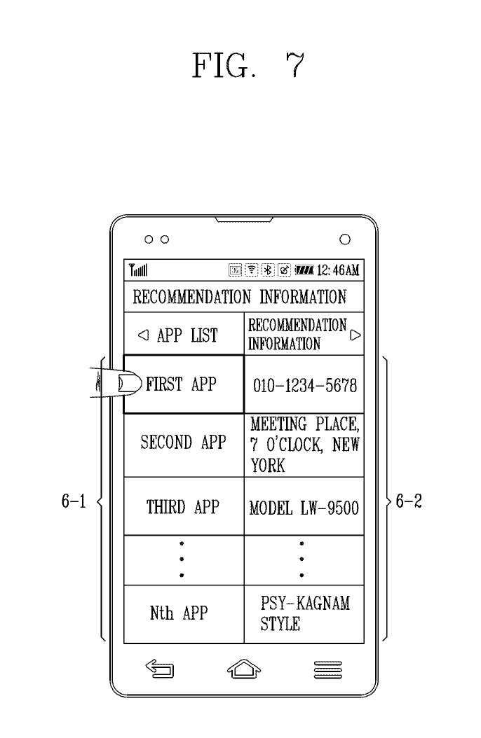

FIG. 7 is a view illustrating an example of recommendation information according to the first exemplary embodiment of the present disclosure.

As illustrated in FIG. 7, when the recommendation information stored in the memory 160 is requested by the user, the control unit 180 may display an item 6-1 representing application programs (for example, the first App, the second App, the third App, . . . , the Nth App) in which the recommendation information is used and recommendation information (for example, a phone number, character, and the like) 6-2 used in each application program (for example, the first App) partitively on the display unit 151. The recommendation information 6-2 may be recommendation information which has been most recently used or may be information having high frequency in use.

When a specific character is input to the character (or message) input window by the user, the control unit 180 may detect characters associated with the input specific character from the recommendation information used in each application program, and information (for example, a thumbnail information of an application program, a name of an application program, and the like) indicating an application in which the detected character is used, partitively on the display unit 151.

When specific information among the recommendation information (for example, a phone number, character, a character string) 6-2 used in each application program (for example, the first App) is selected (or touched) by the user, the control unit 180 displays the selected information in the character (or message) input window.

When an item indicating a specific application program (for example, the first App) among the application programs (for example, the first App, the second App, the third App, . . . , the Nth App) in which the recommendation information is used is dragged or touched by the user in a specific direction (for example, in a leftward direction or in a rightward direction), the control unit 180 may display various types of recommendation information used in the specific application program (for example, in the first App) on the display unit 151.

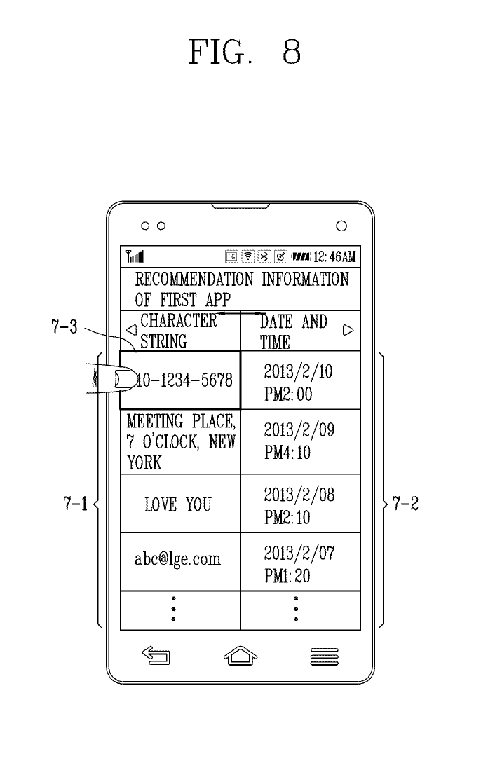

FIG. 8 is a view illustrating another example of recommendation information according to the first exemplary embodiment of the present disclosure.

As illustrated in FIG. 8, when an item indicating a specific application program (for example, the first App) among the application programs (for example, the first App, the second App, the third App, . . . , the Nth App) in which the recommendation information is used is dragged or touched by the user in a specific direction (for example, in a leftward direction or in a rightward direction), the control unit 180 may display various types of recommendation information 7-1 used in the specific application program (for example, in the first App) in order of frequency in use (that is, in order, starting from recommendation information having the highest frequency in use), or in order of date and time 7-2 (that is, starting from recommendation information which has been most recently used), on the display unit 151.

When a specific recommendation information 7-3, among the various types of recommendation information partitively displayed according to application programs, is selected (touched) by the user, the control unit 180 displays the selected recommendation information 7-3 in the character (or message) input window.

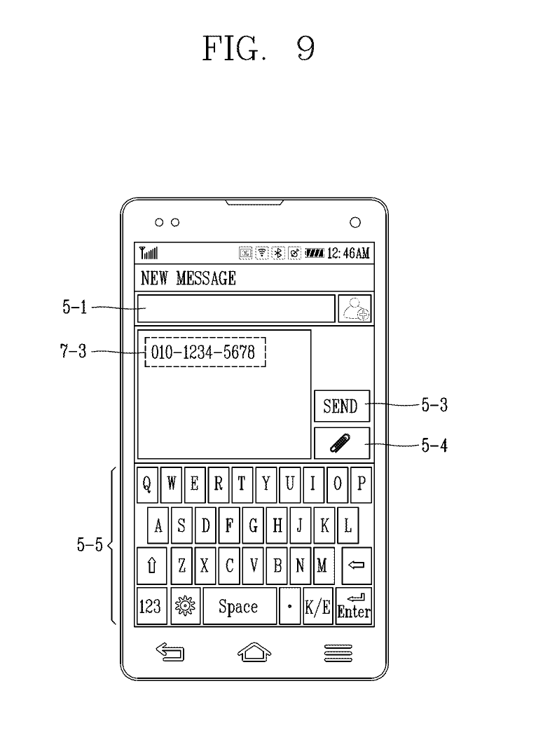

FIG. 9 is a view illustrating an example of recommendation information displayed in a text (or message) input window according to the first exemplary embodiment of the present disclosure.

As illustrated in FIG. 9, when the specific recommendation information 7-3, among the various types of recommendation information partitively displayed according to application programs, is selected (touched) by the user, the control unit 180 automatically displays the selected recommendation information 7-3 in the character (or message) input window.

Thus, in the apparatus for controlling a mobile terminal and the method thereof according to the first exemplary embodiment of the present disclosure, after information (for example, a character string, a picture, a document, an audio file, a video file, and the like) collected through a plurality of application programs (App) is stored, when a character (or message) input window is activated by the user, the stored information (for example, a recommendation character string) may be provided so that the user may easily and quickly select and transmit desired information.

Hereinafter, an apparatus for controlling a mobile terminal and a method thereof, in which after information (for example, a character string, a picture file, a document file, an audio file, a video file, and the like) collected through a plurality of application programs (App) is stored, when the attachment file icon 5-4 for attaching a file (data file) to be sent together with a character (or a message) is selected by the user, the files (for example, the picture file, the document file, the audio file, the video file, and the like) respectively used in the application programs, among the collected information (for example, the character string, the picture file, the document file, the audio file, the video file, and the like), are detected and displayed so that the user may easily and quickly select and transmit a desired file will be described with reference to FIGS. 1 through 14.

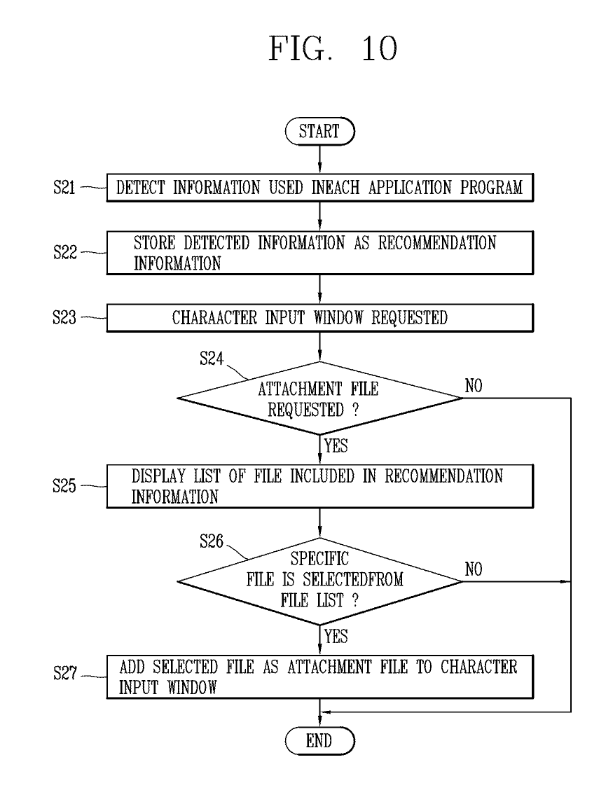

FIG. 10 is a flow chart illustrating a method for controlling a mobile terminal according to a second exemplary embodiment of the present disclosure.

First, the control unit 180 displays an application program list including application programs installed in the mobile terminal 100 on the display unit 151 according to a user request. For example, when the application program list for selecting an application program for detecting recommendation information (for example, a character string, a picture, a document, an audio file, a video file, and the like) is requested by the user, the control unit 180 displays the application program list on the display unit 151. The application program list includes a plurality of application programs (first App, second App, . . . , Nth App) and check boxes for selecting an application program for detecting recommendation information (for example, a character, a character string, a photo file, a document file, an audio file, a video file, and the like). The plurality of application programs may include an application program related to a message, an application program related to audio (music), an application program related to a picture (an image), an application program related to video, an application program related to a document, an application program related to a phone call, an application program related to navigation, and the like.

The control unit 180 detects (collects) information used in each application program (for example, an application program related to a message, an application program related to audio (music), an application program related to photograph (image), an application program related to video, an application program related to a document, an application program related to a phone call, an application program related to navigation, and the like) installed in the mobile terminal 100 in step S21. For example, the control unit 180 detects input information and received information through an application program selected from the application program list among the application programs installed in the mobile terminal 100. When the application program selected from the application program list is a message-related application program, the control unit 180 detects a message used in the message-related application program. When the application program selected from the application program list is an audio (music)-related application program, the control unit 180 detects audio (music file) used in the audio (music)-related application program. When the application program selected from the application program list is a document-related application program, the control unit 180 detects a character and/or a character string used in the document-related application program.

After the used information is detected (or collected), the control unit 180 stores the used information as recommendation information in the memory 160 in step S22. The control unit 180 may store the most recently used information and/or information with high frequency in use (periodically used information or information which has been used by a number of times equal to or greater than a preset number of times) as the recommendation information in the memory 160. The recommendation information may further include a title of the corresponding application program, category information of the corresponding application program, a thumbnail image of the corresponding application program, a date and a time on and at which the recommendation information was generated, and the like.

The control unit 180 determines whether a text input window (or a message input window) is requested by the user. For example, the control unit 180 determines whether the text or message-related application program is selected by the user.

When a text input window (or a message input window) is requested by the user, the control unit 180 displays the text input window (or the message input window) on the display unit 151 in step S23. For example, when the text or the message-related application is selected by the user, the control unit 180 displays a text or message input window for inputting a text or message on the display unit 151.

The control unit 180 determines whether an attachment file to be sent together with the character or the message is requested by the user in step S24. For example, the control unit 180 may determine whether the attachment file icon 5-4 included in the character or message input window is selected by the user, or determines whether a preset voice (for example, a voice corresponding to an attachment file, a document file, an audio file, a video file, a picture file, and the like) is received through the microphone 122.

When the attachment file is requested by the user in a state in which the text or message input window is displayed on the display unit 151, the control unit 180 detects files information (for example, a document file, an audio file, a video file, a picture file, and the like) included in the stored recommendation information, and displays a list of the detected files on the display unit 151 in step S25.

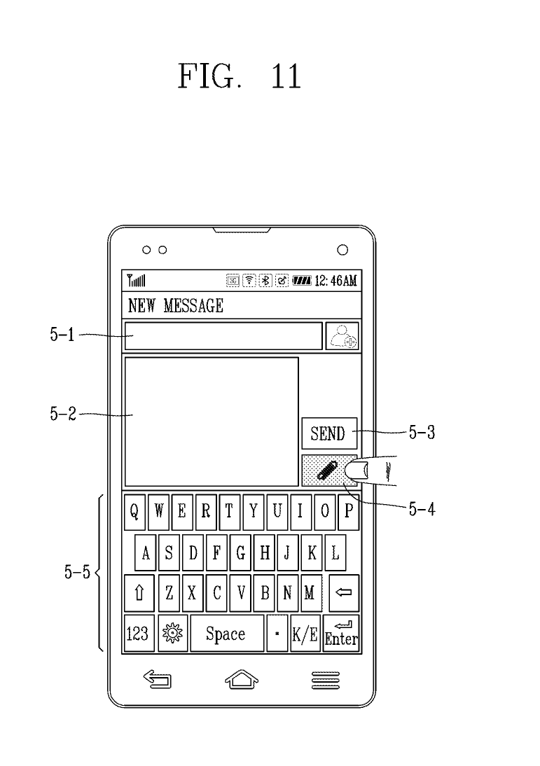

FIG. 11 is a view illustrating an example of an attachment file icon included in a message input window according to the second exemplary embodiment of the present disclosure.

As illustrated in FIG. 11, when the attachment file icon 5-4 included in the character or message input window is selected by the user, the control unit 180 detects files (for example, a document file, an audio file, a video file, a picture file, and the like) included in the stored recommendation information, and displays a list of the detected files on the display unit 151. The control unit 180 may display the files included in the recommendation information in order, starting from the most recently used file in each application program, or in order, starting from a file having the highest frequency in use.

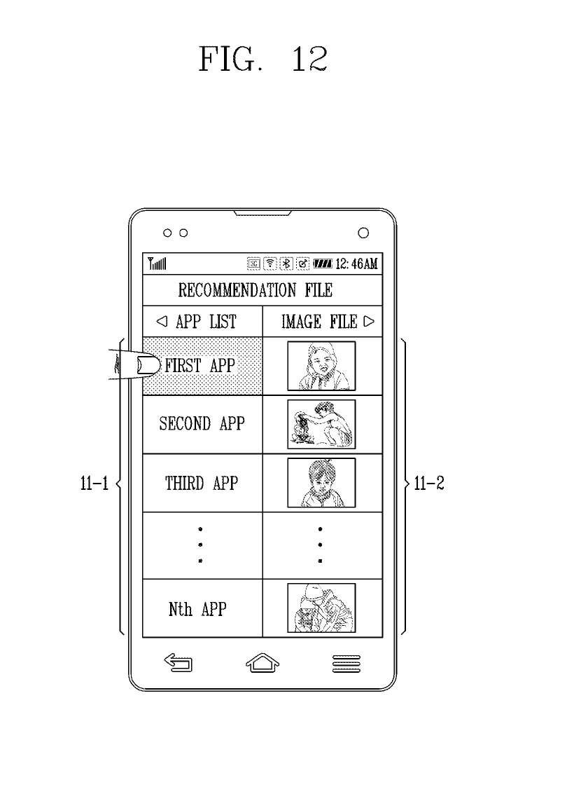

FIG. 12 is a view illustrating an example of a recommendation file according to the second exemplary embodiment of the present disclosure.

As illustrated in FIG. 12, when a file to be sent together with the character (or message) is requested by the user, the control unit 180 displays items 11-1 representing application programs (for example, first App, second App, third App . . . , Nth App) in which the files have been used, and files (for example, an image file, an audio file, a video file, a document file, a picture file, and the like) 11-2 which have been respectively used in the applications for example, first App, second App, third App . . . , Nth App) on the display unit 151. The files 11-2 may be files which have been mostly recently used or may be files with high frequency in use. When a preset voice (for example, a voice corresponding to an image file) is received, the control unit 180 may detect image files used in the application programs and partitively display the detected image files and information (for example, a thumbnail image of the application, a title of the application program, and the like) indicating the application programs in which the image files have been used, on the display unit 151.

When a specific file (for example, the image file), among the files (for example, the mage file, the audio file, the picture file, the document file, the video file, and the like) used in the application programs (for example, first App), is selected (or touched) by the user, the control unit 180 attaches the selected specific file as the attachment file to the text (or message) input window.

When an item representing a specific application program (for example, the first App), among the application programs (for example, the first App, the second App, the third App, . . . , and the Nth App) in which the recommendation information has been used, is dragged or touched by the user in a specific direction (for example, in a leftward direction or in a rightward direction), the control unit 180 may partitively display various files used in the specific application program (for example, the first App) on the display unit 151.

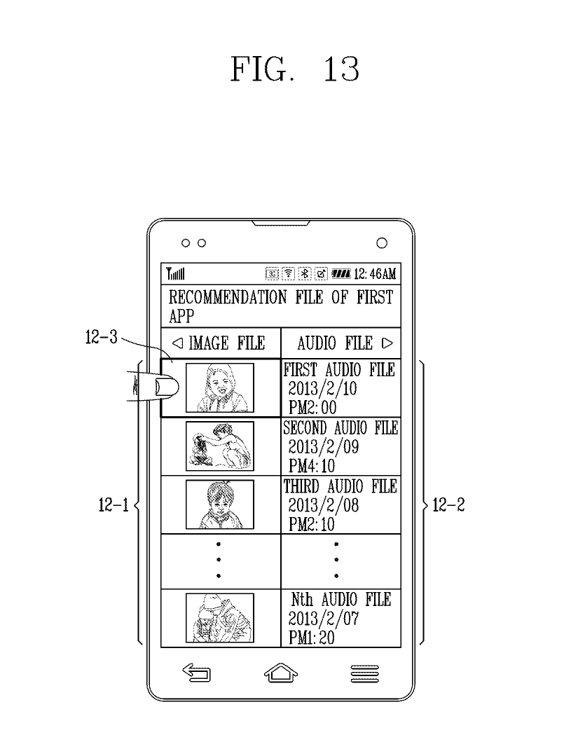

FIG. 13 is a view illustrating another example of files according to the second exemplary embodiment of the present disclosure.

As illustrated in FIG. 13, when an item representing a specific application program (for example, the first App), among the application programs (for example, the first App, the second App, the third App, . . . , and the Nth App) in which the files has been used, is dragged or touched by the user in a specific direction (for example, in a leftward direction or in a rightward direction), the control unit 180 may partitively display various files 12-1 and 12-2 (for example, image files, audio files, and the like) used in the specific application program (for example, the first App) in order of frequency in use (that is, starting from the image file or the audio file having the highest frequency in use), or in order of date and time (that is, starting from the image file or the audio file which has been most recently used), on the display unit 151.

When a specific file 12-3, among the files partitively displayed according to application programs, is selected (or touched) by the user, the control unit 180 automatically displays (adds or attaches) the selected specific file 12-3 in the character (or message) input window.

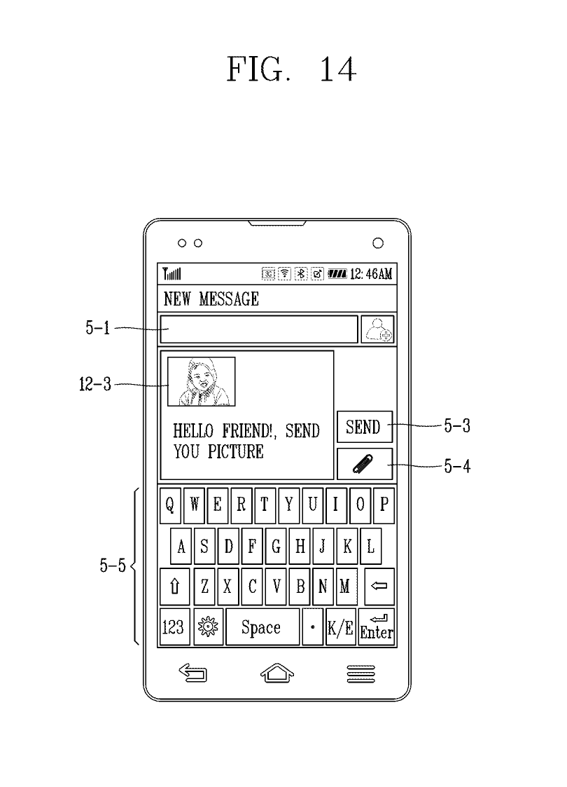

FIG. 14 is a view illustrating an example of a recommendation file displayed in a text (or message) input window according to the second exemplary embodiment of the present disclosure.

As illustrated in FIG. 14, when the specific recommendation file 12-3, among recommendation files partitively displayed according to application programs, is selected (or touched) by the user, the control unit 180 automatically displays (adds or attaches) the selected recommendation file 12-3 in the character (or the message) input window.

Thus, in the apparatus for controlling a mobile terminal and the method thereof according to the second exemplary embodiment of the present disclosure, information (for example, a character string, a picture file, a document file, an audio file, a video file, and the like) collected through a plurality of application programs (App), and thereafter, when the attachment file icon 5-4 for attaching a file (data file) to be sent together with a character (or a message) is selected by the user, files used in each application program are detected from the collected information (for example, a character string, a picture file, a document file, an audio file, a video file, and the like), and displayed, whereby the user may easily and quickly select and transmit a desired file.

It will be apparent to those skilled in the art that modifications and variations can be made without departing from the spirit and scope of the invention. Thus, this description is intended to be illustrative, and not to limit the scope of the claims. Also, although an embodiment has not been described in the above disclosure, it should be extensively construed within the scope of the technical concept defined in the claims. And, various changes and modifications that fall within the scope of the claims, or equivalents of such scope are therefore intended to be embraced by the appended claims.

What is claimed is:

1. A method for controlling a mobile terminal, the method comprising;
detecting information used in at least one application program;
displaying a character input window on a display unit; and
displaying information selected from the detected information in the character input window.

2. The method of claim 1, wherein the information used in the at least one application program is information which has been most recently used in the at least one application program or is information having high frequency in use among information used in the at least one application program.

3. The method of claim 1, wherein the information selected from the detected information is information associated with information input to the character input window among the detected information.

4. The method of claim 1, further comprising:
displaying the detected information on the display unit.

5. The method of claim 4, wherein the detected information comprises:
first information indicating at least one application program in which the information has been used;
second information indicating information used in the at least one application program; and
third information indicating a date and time on and at which the second information has been generated.

6. The method of claim 1, wherein the detected information is one or more of a character, a character string, a phone number, an image file, a video file, an audio file, and a document file.

7. The method of claim 1, wherein the detecting of information comprises:
selecting at least one application program from an application program list;
detecting information used in the selected application program; and
storing the detected information as recommendation information in a storage unit.

8. The method of claim 1, further comprising:
when a file is requested in a state in which the character input window is displayed on the display unit, detecting files from the detected information; and
displaying a list of the detected files on the display unit.

9. The method of claim 8, wherein a file selected from the displayed list is attached to the character input window.

10. The method of claim 1, wherein the file is any one of a document file, an audio file, a video file, and a picture file, and
the method further comprising:
when a voice for requesting any one of the document file, the audio file, the video file, and the picture file is received, detecting a file corresponding to the received voice from the recommendation information; and
displaying the detected file on the display unit.

11. A mobile terminal comprising:
a control unit configured to detect information used in at least one application program; and
a display unit configured to display a character input window,
wherein the control unit displays information selected from the detected information in the character input window.

12. The mobile terminal of claim 11, wherein the information used in the at least one application program is information which has been most recently used in the at least one application program or is information having high frequency in use among information used in the at least one application program.

13. The mobile terminal of claim 11, wherein the information selected from the detected information is information associated with information input to the character input window among the detected information.

14. The mobile terminal of claim 11, wherein the control unit displays the detected information on the display unit.

15. The mobile terminal of claim 14, wherein the detected information comprises:
first information indicating at least one application program in which the information has been used;
second information indicating information used in the at least one application program; and
third information indicating a date and time on and at which the second information has been generated.

16. The mobile terminal of claim 11, wherein the detected information is one or more of a character, a character string, a phone number, an image file, a video file, an audio file, and a document file.

17. The mobile terminal of claim 11, wherein the control unit selects at least one application program from an application program list, detects information used in the selected application program, and stores the detected information as recommendation information in a storage unit.

18. The mobile terminal of claim 11, wherein when a file is requested in a state in which the character input window is displayed on the display unit, the control unit detects files from the detected information and displays a list of the detected files on the display unit.

19. The mobile terminal of claim 18, wherein the control unit attaches a file selected from the displayed list to the character input window.

20. The mobile terminal of claim 11, wherein the file is any one of a document file, an audio file, a video file, and a picture file, and when a voice for requesting any one of the document file, the audio file, the video file, and the picture file is received, the control unit detects a file corresponding to the received voice from the recommendation information and displays the detected file on the display unit.
